(19) United States
(12) Patent Application Publication
(10) Pub. No.: US 2005/0128954 A1
(43) Pub. Date: Jun. 16, 2005

(54) Method for transmission rate adapatation

(76) Inventors: Kuo-Hui Li, Hsinchu (TW); Chi-Chao Chao, Hsinchu (TW)

Correspondence Address: RABIN & Berdo, PC, 1101 14TH STREET, NW, SUITE 500, WASHINGTON, DC, 20005, US

(21) Appl. No.: 10/728,829

(22) Filed: Dec. 8, 2003

(51) Int. Cl. H04J 1/16; H04L 12/28; H04L 12/56

(52) U.S. Cl. 370/252; 370/349

(57) ABSTRACT

A method for transmission rate adaptation used in a wireless network. A current transmission rate is selected from a set of predetermined transmission rates. Each of the predetermined transmission rates, R, is associated with a PER (packet error rate) range, which includes a predetermined threshold pair of a high PER threshold, denoted as Q_{H}(R), and a low PER threshold, denoted as Q_{L}(R). First, calculate a first estimated PER, denoted as P1(rₙ), wherein rₙ denotes the current transmission rate. Then, check whether the P1(rₙ) is larger than the Q_{H}(rₙ), if yes, reduce the transmission rate. Then, calculate a second estimated PER, denoted as P2(rₙ), and check whether the P2(rₙ) is smaller than the Q_{L}(rₙ), if yes, increase the transmission rate. And, check whether the P2(rₙ) being larger than the Q_{H}(rₙ), if yes, reduce the transmission rate.

### BACKGROUND OF THE INVENTION

1. Field of the Invention

The invention relates in general to the method for transmission rate adaptation, and more particularly to the method for transmission rate adaptation.

2. Description of the Related Art

The advantage of wireless communication system is the increased mobility, because data are transmitted through air using radio bands instead of cables. Users of wireless communication systems can move about almost without restrictions and access information from nearly everywhere. IEEE 802.11 a/b/g standards are used for wireless LAN (local area network). IEEE 802.11a uses OFDM (Orthogonal Frequency Division Multiplexing) modulation technology and specifies the transmission rates of 54M, 48M, 36M, 24M, 12M, 9M and 6 Mbps. IEEE 802.11b uses spread spectrum modulation technology and specifies the transmission rates of 11 M, 5.5M, 2M and 1M. IEEE 802.11g uses both OFDM and spread spectrum modulation technologies and specifies the transmission rates included in IEEE 802.11a and IEEE 802.11b for full backward compatibility.

The actual throughput in wireless LANs is dependent upon the network product and the communication environment. Factors that affect the actual throughput include number of users and propagation factors such as range and multipath, etc.

The transmission rate of the wireless LAN according to IEEE 802.11a/b/g is dynamically adaptable during data transmission in order to achieve the best throughput. However, the algorithm of performing dynamic rate switching is not instructed in the IEEE 802.11a/b/g standards and left as an implementation issue.

### SUMMARY OF THE INVENTION

It is therefore an object of the invention to provide a method for transmission rate adaptation.

The invention achieves the above-identified objects by providing a new method for transmission rate adaptation used in a wireless network. A current transmission rate is selected from a set of predetermined transmission rates. Each of the transmission rates, R, is associated with a PER (packet error rate) range, which includes a predetermined threshold pair of a high PER threshold, denoted as Q_{H}(R), and a low PER threshold, denoted as Q_{L}(R). First, calculate a first estimated PER, denoted as P1(rₙ), wherein rₙ denotes the transmission rate at the n-th adaptation iteration. Then, check whether the P1(rₙ) is larger than the Q_{H}(rₙ), if yes, reduce the transmission rate. Then, calculate a second estimated PER, denoted as P2(rₙ), and check whether the P2(rₙ) is smaller than the Q_{L}(rₙ), if yes, increase the transmission rate. And, check whether the P2(rₙ) being larger than the Q_{H}(rₙ), if yes, reduce the transmission rate.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a graph that shows the relation of the system packet error rate (PER) vs. received power P at different transmission rates of a PHY design.

FIG. 2 is a graph that shows the relation of the system throughput vs. received power P.

FIG. 3 is a table that shows the PER ranges for each transmission rate.

FIGS. 4A and 4B are the flowchart of the method of transmission rate adaptation of a preferred embodiment according to the invention.

FIGS. 5A and 5b are flowcharts of the procedure for estimating the PER P1(rₙ) and P2(rₙ) respectively.

FIG. 6 is the flowchart of the procedure for adapting the PER range.

FIG. 7 is the flowchart of the procedure for checking if the ping-pong event occurs.

### DETAILED DESCRIPTION OF THE INVENTION

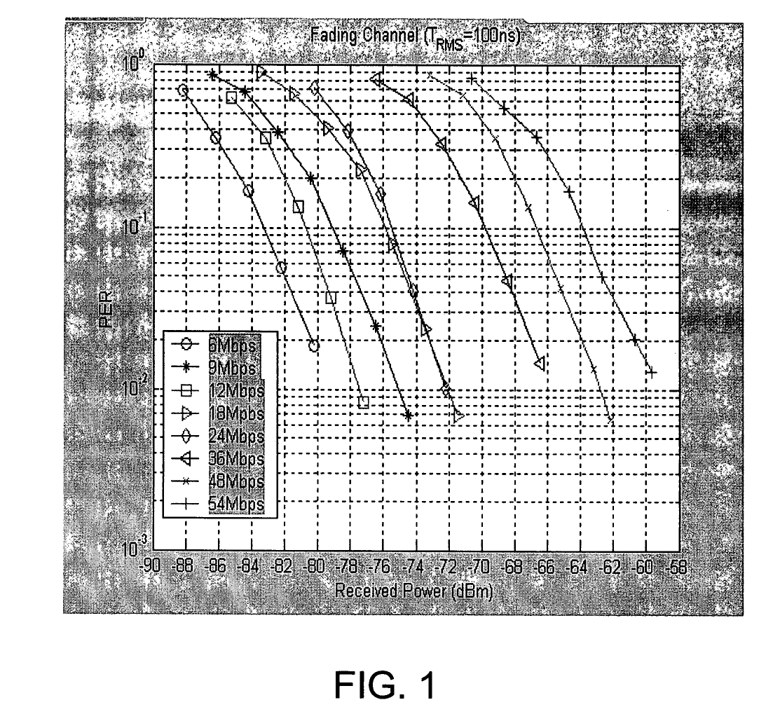

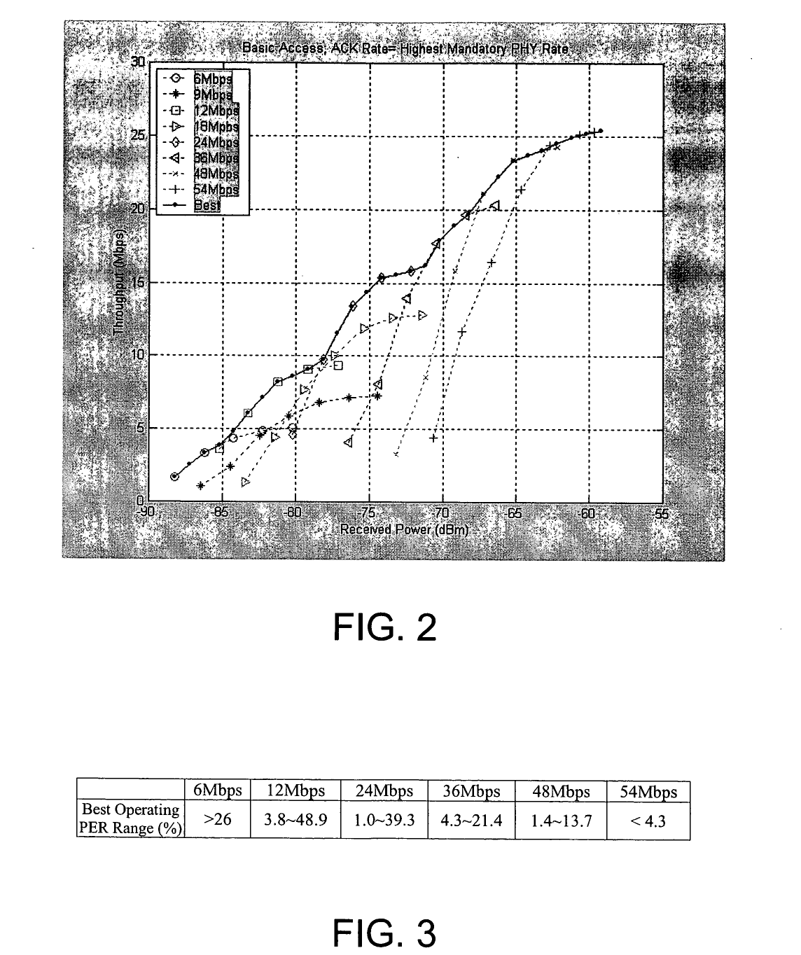

FIG. 1 is a graph that shows the relation of the system packet error rate (PER) vs. received power P at different transmission rates of a PHY design. The system PER is reduced if the received power P is increased for each transmission rate. FIG. 2 is a graph that shows the relation of the system throughput vs. received power P. The throughput is increased if the received power P is increased for each transmission rate. It is observed in FIG. 2 that the best system throughput is achieved by adapting the transmission rate according to the received power P. Each transmission rate corresponds to a power range in order to achieve the best system throughput. Further, a PER range is obtained in correspondence to the power range of each transmission rate according to the relation of PER vs. received power in FIG. 1. FIG. 3 is a table that shows the PER ranges for each transmission rate. The PER range for each transmission rate R includes a high PER threshold, denoted as Q_{H}(R), and a low PER threshold, denoted as Q_{L}(R). The transmission rate adaptation of this invention can be executed according to the PER range.

For each adaptation iteration, the transmission rate rₙ of the wireless system is selected from a set of predetermined transmission rates {R₀, . . . , R_{W}}, where n denotes the adaptation iteration index, W is an integer and R₀<R₁< . . . <R_{W}. Take the case shown in FIG. 3 as an example, one have W=5 and {R_{W}, . . . , R₀}={54M, 48M, 36M, 24M, 12M, 6M}. In other words, the transmission rate rₙ at the n-th iteration is equal to Rₖ, wherein 0=<k<=W and k is an integer. Each of the predetermined transmission rates, Rε{R₀, . . . , R_{W}}, is associated with a PER range, as listed in FIG. 3, which includes a predetermined threshold pair of a high PER (packet error rate) threshold, denoted as Q_{H}(R), and a low PER threshold, denoted as Q_{L}(R).

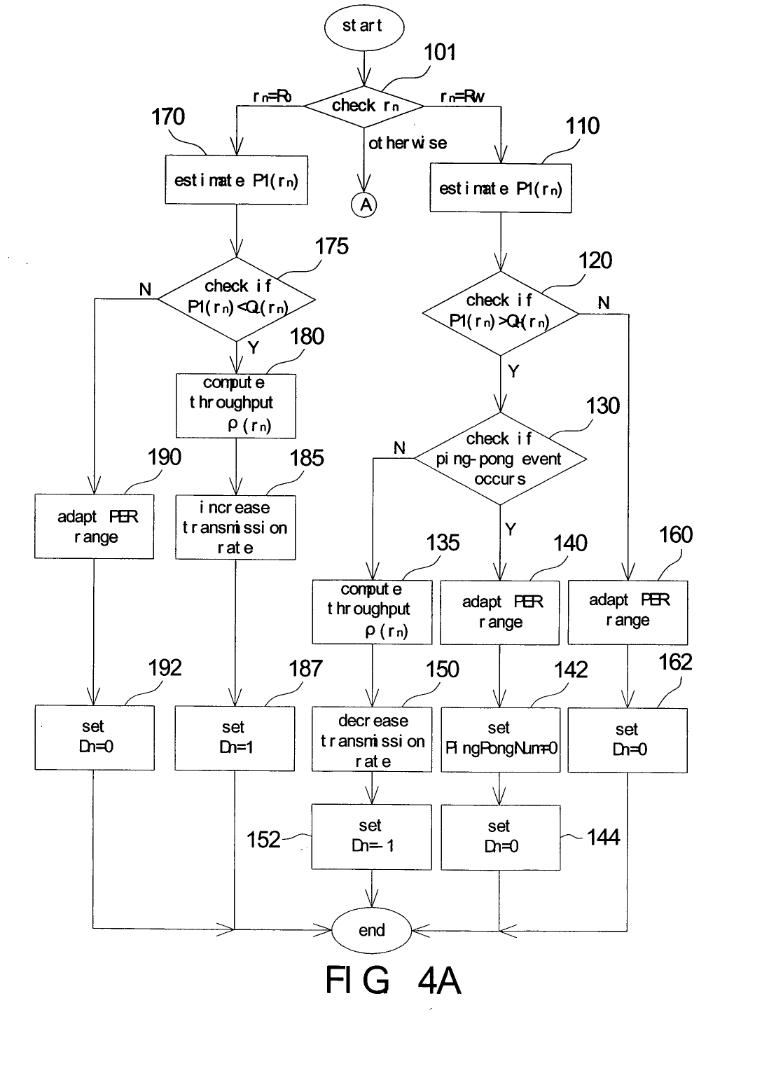

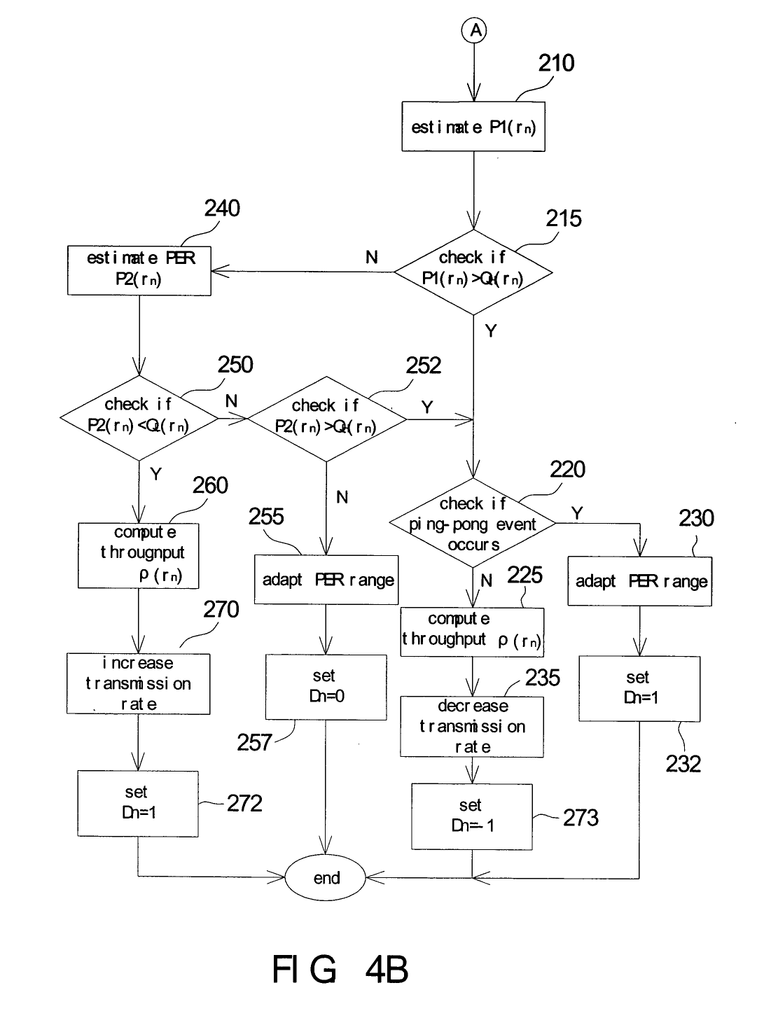

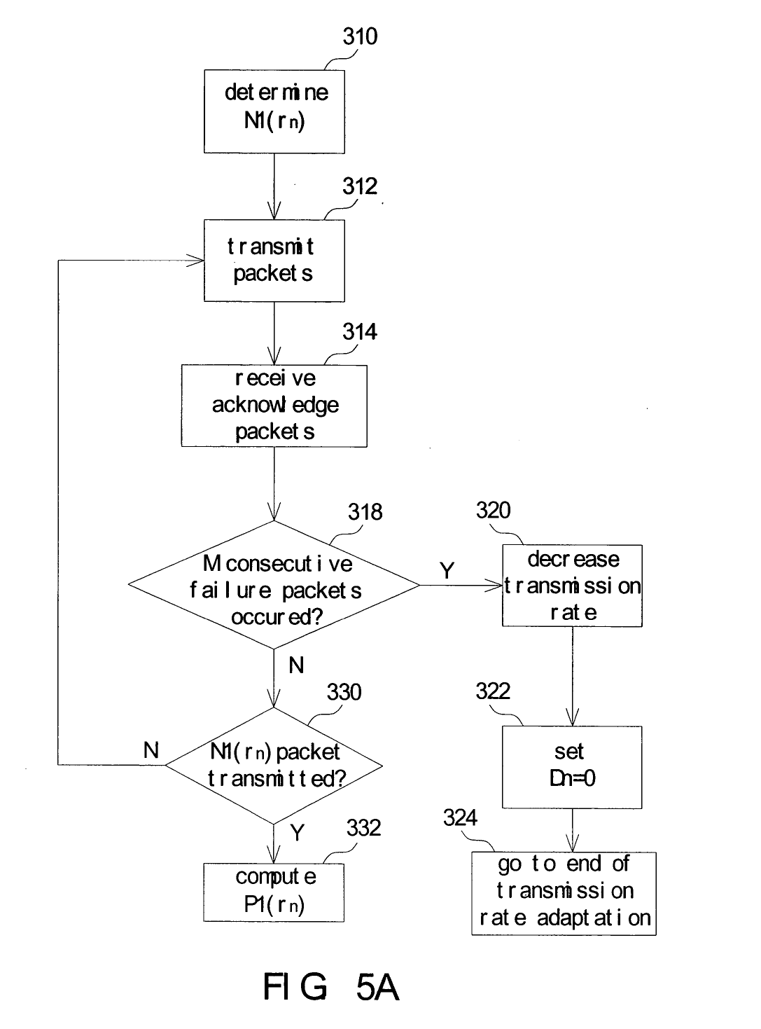

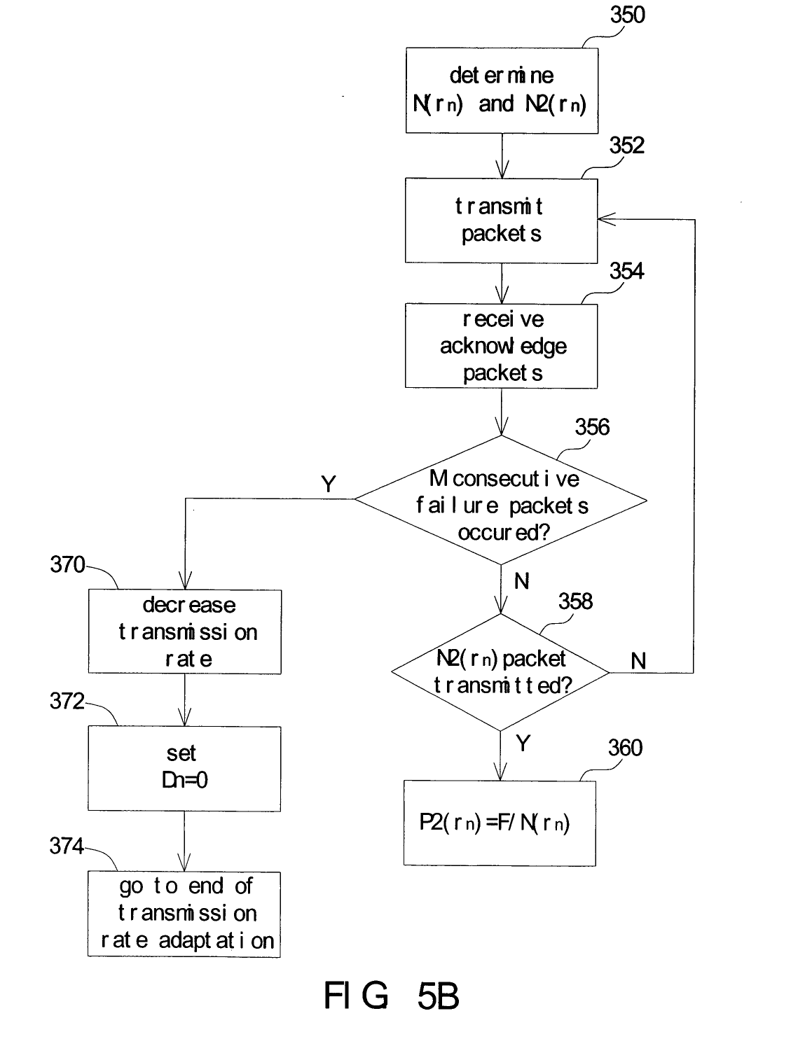

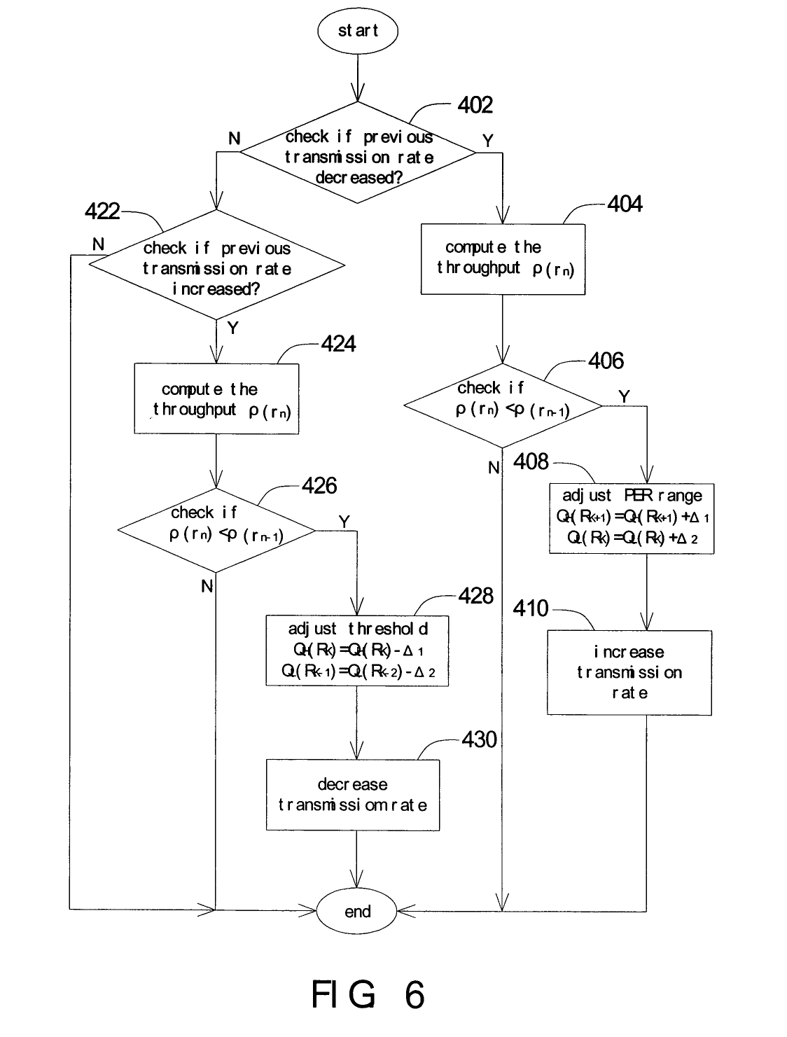

FIG. 4A is the flowchart of the method of transmission rate adaptation of a preferred embodiment according to the invention. Consider the current iteration is the n-th iteration, and the (n−)-th iteration is called the previous iteration. Let rₙ and rₙ₋₁ denote the transmission rate at current and previous iteration, respectively. First, check the transmission rate rₙ at current iteration (step 101): if the current transmission rate is of the highest, R_{W}, process step 110, else if the current transmission rate rₙ is of the slowest, R₀, process step 170, otherwise enter node A. At step 110, estimate the PER P1(rₙ) of the current transmission rate rₙ. The procedure for estimating PER P1(rₙ) is shown in FIG. 5A, and will be discussed later. Then, check if the PER P1(rₙ) is larger than the high PER threshold Q_{H}(rₙ) (step 120). If the PER P1(rₙ) is larger than the high PER threshold Q_{H}(rₙ), steps 130˜152 are processed to determine whether the transmission rate should be decreased, else process step 160. In step 160, PER range is adapted for better transmission throughput. Then, set the adapting direction parameter Dₙ to 0 (step 162). The adapting direction parameter Dₙ is used to record the change of the transmission rate. Dₙ is initially zero. If from the n-th iteration to the (n+1)-th iteration, the transmission rate is increased, Dₙ is set to 1; if the transmission rate is decreased, Dₙ is set to −1. The procedure for adapting the PER range is shown in FIG. 6 and will be discussed later.

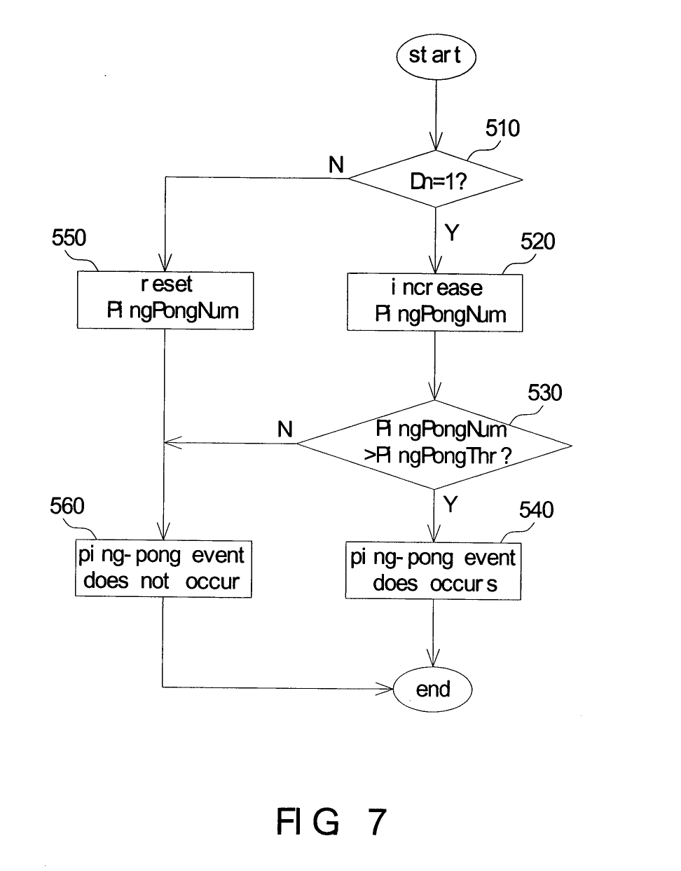

At step 130, check if a ping-pong event occurs according to a ping-pong parameter PingPongNum. The ping-pong event is that the transmission rate varies between two adjacent rates, such as Rₖ and Rₖ₊₁, alternatively. PingPongNum is used to record the times of the transmission rate variation times. The procedure for determining if a ping-pong event occurs is shown in FIG. 7 and will be discussed later. If the ping-pong event occurs, the PER range should be adapted (step 140) to prevent the ping-pong event from happening again. After adapting the PER range, the parameter PingPongNum is reset to 0 (step 142) and the adapting direction parameter, Dₙ, is set to 0, representing that the transmission rate r is not changed (step 144). If the ping-pong event does not occur, the system throughput ?(rₙ) at the current iteration is calculated according to the PER P1(rₙ) (step 135) and the transmission rate is decreased to R_{W-1} (step 150). Then the adapting direction parameter, Dₙ, is set to −1 (step 152).

At step 170, wherein the current transmission rate rₙ is the lowest one, R₀, the PER P1(rₙ) is estimated. The procedure for estimating the PER P1(rₙ) is the same as step 110. Then, check if the PER P1(rₙ) is smaller than the low PER threshold Q_{L}(rₙ) (step 175). If the PER P1(rₙ) is not smaller than the low PER threshold Q_{L}(rₙ), step 190 is processed to adapt the PER range and set the adapting direction parameter, Dₙ, to 0 (step 192). Otherwise, the system throughput ?(rₙ) at current iteration is calculated according to the PER P1(rₙ) (step 180), the transmission rate is increased to R₁ (step 185), and the adapting direction parameter, Dₙ, is set to 1 (step 187).

FIG. 4B is a flowchart of the transmission rate adaptation while the current transmission rate rₙ is neither the highest nor the slowest. Consider rₙ=Rₖ, kε{1,2, . . . , W−1}. First, estimate the PER P1(rₙ) (step 210). Then, check if the PER P1(rₙ) larger than the high PER threshold Q_{H}(rₙ) (step 215), if so, step 220 is processed, else step 240 is processed. In step 220, check if the ping-pong event occurs, if so, adapt the PER range (step 230) and set the adapting direction parameter, Dₙ, to 0; otherwise process step 225. In step 225, the system throughput ?(rₙ) at current iteration is computed (step 225). In addition, the transmission rate is decreased (step 235) and the adapting direction parameter, Dₙ, is set to −1 (step 237).

In step 240, estimate PER P2(rₙ). The procedure for estimating PER P2(rₙ) is shown in FIG. 5B and will be discussed later. Then check if PER P2(rₙ) smaller than the low PER threshold Q_{L}(rₙ) (step 250), if so, process step 260 else process step 252. In step 260, calculate the system throughput ?(rₙ). In addition, increase the transmission rate (step 270) and set the adapting direction parameter, Dₙ, to 1 (step 272). In step 252, check if the PER P2(rₙ) larger than the high PER threshold Q_{H}(rₙ), if so, process step 220, else adapt the PER range (step 255) and set the adapting direction parameter, Dₙ, to 0 (step 257).

The throughput ? is computed using the following equation:
?=?₀(r)(1−p) (1)
wherein ?₀(r) is the theoretical throughput of a transmission rate r under the condition of no packet errors, p is the PER. In steps 135 and 180, ?(rₙ)=?₀(rₙ)(1−P1(rₙ)). In step 260, ?(rₙ)=?₀(rₙ)(1−P2(rₙ)). In step 225, if the previous step of step 220 is 215, ?(rₙ)=?₀(rₙ)(1−P1(rₙ)), else ?(rₙ)=?₀(rₙ) (1−P2(rₙ)).

FIG. 5A is a flowchart of the procedure for estimating the PER P1(rₙ) used by steps 110, 170 and 210. The procedure of estimating the PER P1(rₙ) is mainly to transmit a plurality of packets, receive the acknowledge packets and then estimate the PER P1(rₙ) according to the ratio of the quantity of the failure packets to that of the transmitted packets. A failure packet is the packet that is transmitted but no corresponding acknowledge packet is received or the received acknowledge packet is not correct. First of the procedure, determine a number N1(rₙ) according to the high PER threshold Q_{H}(rₙ) (step 310). Ideally, the PER P1(rₙ) is more accurate if the number N1(rₙ) is larger, but the time to send a large number of packets for estimating PER P1(rₙ) would be too long. In the embodiment, N1(rₙ) is determined by the following equation such that the time to estimate PER P1(rₙ) is not too long while the estimated PER P1(rₙ) is still acceptable:
N1(rₙ)=ceil(a/Q_{H}(rₙ)) (2)
, wherein a is a scalar factor, i.e. α=2, determined by experiments and ceil(·) is a function to get the minimal integer greater than the argument. Then, start to transmit packets (step 312). Then, receive the acknowledge packets corresponding to the transmitted packets (step 314). Check if M consecutive failure packets occurred (step 318), wherein M is an positive integer and is determined by experiments. If M consecutive failure packets occurred, decrease the transmission rate (step 320), set adapting direction parameter, Dₙ, to −1 (step 322) and go to the end of this method of transmission rate adaptation (step 324). At step 330, check if the number of the transmitted packets reaches N1(rₙ), if not, go back to step 312 to continue transmitting packets, else process step 332 to estimating the PER P1(rₙ). Suppose that the quantity of failure packets is F1, and then PER P1(rₙ) can be estimated by the following equation:
P1(rₙ)=F1/N1(rₙ) (3)

FIG. 5B is a flowchart of the procedure for estimating the PER P2(rₙ) used by steps 240. In principle, the procedure of estimating the PER P2(rₙ) is to transmit a plurality of packets, receive the acknowledge packets and then estimating the PER P2(rₙ) according to the ratio of the quantity of the failed packets to that of the transmitted packets. First, determine a number N(rₙ) according to the low PER threshold Q_{L}(rₙ) (step 350). N(rₙ) is determined by the following function:
N(rₙ)=ceil(a/Q_{L}(rₙ)) (4)
, wherein a is a value, i.e. α=2, determined by experiments. Then, a number N2(rₙ) is calculated, which equals to N(rₙ)−N1(rₙ). Then, transmit packets (step 352). Then, receive the acknowledge packets of the transmitted packets (step 354). Check if M consecutive failure packets occurred (step 356), wherein M is an positive integer and is determined by experiments. If M consecutive failure packet occurred, decrease the transmission rate (step 370), set adapting direction parameter, Dₙ, to −1 (step 372) and go to the end of this method of transmission rate adaptation (step 374). At step 358, check if the quantity of the transmitted packets reaches N2(rₙ), if not, go back to step 352 to continue transmitting packets, else process step 360 to estimate the PER P2(rₙ). Suppose that the quantity of failure packets is F2, and then PER P2(rₙ) can be estimated by the following functions:
F=F1+F2 (5)
P2(rₙ)=F/N(rₙ) (6)

FIG. 6 is the flowchart of the procedure for adapting the PER range used by steps 140, 160, 190, 230, and 255. Consider the current iteration is the n-th iteration, and the (n-1)-th iteration is called the previous iteration. Let rₙ and rₙ₋₁ denote the transmission rate at current and previous iteration, respectively. First, check if the transmission rate was decreased from the previous to the current iteration (step 402), i.e. rₙ₋₁=Rₖ₊₁, rₙ=Rₖ for some kε{1,2, . . . , W}, if so, process step 404, else process step 422. Note that, the step 402 can be performed by checking the adapting direction parameter Dₙ₋₁ at previous iteration. If the Dₙ₋₁ equals to −1, it means that the transmission rate was decreased, and if the Dₙ₋₁ equals to 1, it means that the transmission rate was increased. In step 404, a system throughput ?(rₙ) at current iteration is calculated according to equation (1). Then, the throughput ?(rₙ) at current iteration is compared with the throughput ?(rₙ₋₁) at previous iteration (step 406), which has been calculated at the previous iteration. If the ?(rₙ) is smaller than the ?(rₙ₋₁), the PER range is adapted as follows (step 408):
Q_{H}(Rₖ₊₁)=Q_{H}(Rₖ₊₁)+?₁ (7)
Q_{L}(Rₖ)=Q_{L}(Rₖ)+?₂ (8)
where Δ₁ and Δ₂ are preset parameters. In addition, the current transmission rate rₙ is returned to the one at the previous iteration by increasing the transmission rate from Rₖ to Rₖ₊₁(step 410). If the current throughput ?(rₙ) is not smaller than previous throughput ?(rₙ₋₁), the PER range is not adapted.

At step 422, check if the transmission rate was increased from the previous to the current iteration, i.e. rₙ₋₁=Rₖ₋₁, rₙ=Rₖ for some kε{0,1, . . . , W}, if so, process step 424. In step 424, a system throughput ?(rₙ) at current iteration is calculated according to equation (1). Then, the current throughput ?(rₙ) is compared with the previous throughput ?(rₙ₋₁)(step 426), which has been calculated at the previous iteration. If the current throughput ?(rₙ) is smaller than the previous throughput ?(rₙ₋₁), the PER range is adapted as follows (step 428):
Q_{H}(Rₖ)=Q_{H}(Rₖ)−?₁ (9)
Q_{L}(Rₖ₋₁)=Q_{L}(Rₖ₋₁)−?₂ (10)
And, the current transmission rate is returned to the one at the previous iteration by decreasing the transmission rate from Rₖ to Rₖ₋₁ (step 430). If the current throughput ?(rₙ) is not smaller than previous throughput ?(rₙ₋₁), the PER range is not adapted.

FIG. 7 is the flowchart of the procedure for checking if the ping-pong event occurs used by steps 130 and 220, wherein the transmission rate rₙ is going to be decreased in both cases. First, check if the transmission rate rₙ at the current iteration n is increased from the transmission rate rₙ₋₁ at the previous iteration n−1, i.e, check if Dₙ equals to 1 (step 510), if so, process step 520, else process step 550 to reset PingPongNum and then step 560. In step 520, increase the parameter PingPongNum, which records the times of the back-and-forths of the transmission rate between two adjacent rates. Next, check if PingPongNum is larger than the preset ping-pong threshold, denoted as PingPongThr (step 530), if so, the occurrence of the ping-pong event is declared (step 540), else it is declared that the ping-pong event does not occur (step 560).

The best throughput is achieved by the invention, while the ping-pong event is avoided, and the consecutive failure packets are considered. The PER range is also adapted for a better result of the throughput.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method for transmission rate adaptation used in a wireless network, a current transmission rate being selected from a set of predetermined transmission rates, each of the predetermined transmission rates, R, being associated with a PER (packet error rate) range, which includes a predetermined threshold pair of a high PER (packet error rate) threshold, denoted as Q_{H}(R), and a low PER threshold, denoted as Q_{L}(R), the method comprising:
determining a first number N1 and a second number N2 according to the Q_{H}(rₙ) and the Q_{L}(rₙ), respectively, wherein N1 and N2 are positive integers, rₙ denotes the current transmission rate, the subscript n denotes a adaptation iteration index;
transmitting a first plurality of packets, wherein the number of the first plurality of packets is N1;
receiving a first plurality of acknowledge packets, each one in the first plurality of acknowledge packets responding to one of the first plurality of packets, wherein the number of the first plurality of acknowledge packets is A1, A1 is a positive integer and A1<=N1, wherein a first estimated PER, denoted as P1(rₙ), corresponding to the current transmission rate is P1(rₙ)=(N1−A1)/N1;
reducing the transmission rate if the P1(rₙ) being larger than the Q_{H}(rₙ);
transmitting a second plurality of packets, wherein the number of the second plurality of packets is (N2−N1);
receiving a second plurality of acknowledge packets, each one in the second plurality of acknowledge packets responding to one in the second plurality of packets, Wherein the number of the second plurality of acknowledge packets is A2 and A2<=(N2−N1), wherein a second estimated PER, P2(rₙ), corresponding to the current transmission is P2(rₙ)=(N2−A1−A2)/N2;
reducing the transmission rate if the P2(rₙ), being larger than the Q_{H}(rₙ);
increasing the transmission rate if the P2(rₙ) being smaller than the Q_{L}(rₙ); and
keeping the transmission rate if the P2(rₙ) falls between the Q_{H}(rₙ) and the Q_{L}(rₙ);
wherein the numbers N1 and N2 are large enough such that the P1(rₙ) and the P2(rₙ) are substantially reliable.

2. The method according to claim 1, further comprises:
checking if M consecutive packets of the first or second plurality of packets being failed to be acknowledged, if yes, decreasing the transmission rate, wherein M is an integer.

3. The method according to claim 1, wherein the transmission rate remains unchanged if the transmission rate at the step of reducing the transmission rate is the lowest one, or the transmission rate at the step of increasing transmission rate is the highest one.

4. A method for transmission rate adaptation used in a wireless network, a current transmission rate is selected from a set of predetermined transmission rates, each of the predetermined transmission rates, R, being associated with a PER (packet error rate) range, which includes a predetermined threshold pair of a high PER (packet error rate) threshold, denoted as Q_{H}(R), and a low PER threshold, denoted as Q_{L}(R), the method comprising:
(1) calculating a first estimated PER, denoted as P1(rₙ), wherein rₙ denotes the current transmission rate, and the subscript n denotes the adaptation iteration index;
(2) checking whether the P1(rₙ) being larger than the Q_{H}(rₙ), if yes, processing step (3), else processing step (4);
(3) reducing the transmission rate and ending the method;
(4) calculating a second estimated PER, denoted as P2(rₙ);
(5) checking whether the P2(rₙ) being smaller than the Q_{L}(rₙ), if yes, processing step (6), else processing step (7);
(6) increasing the transmission rate and ending the method; and
(7) checking whether the P2(rₙ) being larger than the Q_{H}(rₙ), if yes, processing step (8), else ending the method; and
(8) reducing the transmission rate.

5. The method according to claim 4, wherein step (1) comprises:
determining a first number according to the Q_{H}(rₙ);
transmitting a first plurality of packets, wherein the number of the first plurality of packets equals to the first number;
receiving a first plurality of acknowledge packets, wherein each one in the first plurality of acknowledge packets responding to one of the first plurality of packets; and
calculating the first estimated PER P1(rₙ) according to the number of the first acknowledge packets and the number of the first plurality of packets;
wherein the first number is large enough such that the P1(rₙ) is substantially reliable.

6. The method according to claim 5, wherein the transmission rate is reduced if there are M consecutive ones of the first plurality of packets failed to be acknowledged, wherein M is an integer.

7. The method according to claim 5, wherein step (4) comprises:
determining a second number according to the Q_{L}(rₙ);
transmitting a second plurality of packets, wherein the sum of the number of the second plurality of packets and the number of the first plurality of packets equals to the second number;
receiving a second plurality of acknowledge packets, wherein each one in the second plurality of acknowledge packets responding to one of the second plurality of packets; and
calculating the second estimated PER P2(rₙ), according to the number of the second plurality of acknowledge packets, the number of the first plurality of acknowledge packets and the second number;
wherein the second number is large enough such that the P2(rₙ) is substantially reliable.

8. The method according to claim 7, wherein the transmission rate is reduced if there are M consecutive ones of the second plurality of packets being failed to be acknowledged, wherein M is an integer.

9. The method according to claim 4, wherein step (4) comprises:
transmitting a second plurality of packets, wherein the number of the second plurality of packets is determined according to the Q_{L}(rₙ);
receiving a second plurality of acknowledge packets, wherein each one in the second plurality of acknowledge packets responding to one of the second plurality of packets; and
calculating the second estimated PER P2(rₙ) according to the number of the second plurality of acknowledge packets and the number of the second plurality of packets;
wherein the number of the second plurality of packets is large enough such that the second estimated PER is substantially reliable.

10. The method according to claim 9, wherein the transmission rate is reduced if there are M consecutive ones of the second plurality of packets being failed to be acknowledged, wherein M is an integer.

11. The method according to claim 4, wherein the transmission rate remains unchanged if the transmission rate at the step of reducing the transmission rate is the lowest one, or the transmission rate at the step of increasing transmission rate is the highest one.

12. The method according to claim 4, further comprising a step of adapting PER range, which comprises:
recording an adapting direction parameter Dₙ, being one of a first direction, a second direction, and a third value, and the adapting direction parameter representing that the transmission rate is adapted to a higher one, a lower one, and the same one respectively;
computing an estimated throughput ?(rₙ) associated with the transmission rate rₙ;
determining whether the current estimated throughput ?(rₙ) being smaller than the previous estimated throughput ?(rₙ₋₁) and a previous adapting direction parameter Dₙ₋₁ is of the first direction, if yes, performing a first range adaptation for adapting the low PER threshold Q_{L}(rₙ) associated with the current transmission rate rₙ and the high PER threshold Q_{H}(rₙ₋₁) associated with the previous transmission rate rₙ₋₁, and increasing the transmission rate; and
determining whether the current estimated throughput ?(rₙ) being smaller than the previous estimated throughput ?(rₙ₋₁) and the previous adapting direction parameter Dₙ₋₁ is of the second direction, if yes, performing a second range adaptation for adapting the high PER threshold Q_{H}(rₙ) associated with the current transmission rate rₙ and the low PER threshold Q_{L}(rₙ₋₁) associated with the previous transmission rate rₙ₋₁, and decreasing the transmission rate.

13. The method according to claim 12, wherein the first range adaptation comprises:
increasing the Q_{L}(rₙ) and the Q_{H}(rₙ₋₁) by a first predetermined value and a second predetermined value, respectively.

14. The method according to claim 12, wherein the second range adaptation comprises:
decreasing the Q_{H}(rₙ) and the Q_{L}(rₙ₋₁) by a third predetermined value and a fourth predetermined value, respectively.

15. The method according to claim 12, wherein the calculation of the estimated throughput ?(rₙ) associated with the transmission rate rₙ at adaptation iteration n comprises:
computing a final estimated PER P(rₙ) associated with the transmission rate rₙ, wherein the P(rₙ) equals to the P2(rₙ) if the P2(rₙ) is valid, otherwise, the P(rₙ) equals to the P1(rₙ);
computing the estimated throughput ?(rₙ) based on the P(rₙ) and a predetermined maximal throughput ?₀(rₙ) associated to the transmission rate rₙ at adaptation iteration n.

16. The method according to claim 15, wherein ?(rₙ)=?₀(rₙ)*(1−P(rₙ)).

17. The method according claim 12 further comprising a step for avoiding a ping-pong event, which comprises:
calculating a ping-pong parameter based on the adapting direction parameters Dₙ and Dₙ₋₁, wherein the ping-pong parameter is increased when Dₙ and Dₙ₋₁ represents the opposite direction to each other, otherwise, the ping-pong parameter is reset; and
determining whether the ping-pong parameter being larger than a ping-pong threshold, if yes, processing the step of adapting PER range.

18. The method according to claim 17, wherein the step for avoiding ping-pong event is performed before the step of increasing or decreasing the transmission rate.
